(19) United States
(12) Patent Application Publication
(10) Pub. No.: US 2013/0111778 A1
(43) Pub. Date: May 9, 2013

(54) AIR INLET AND OUTLET DEVICE OF HAND DRYER

(71) Applicant: Zhaokang Bao, Linhai (CN)

(72) Inventor: Zhaokang Bao, Linhai (CN)

(21) Appl. No.: 13/514,597

(22) PCT Filed: May 8, 2012
(86) PCT No.: PCT/CN12/75167

§ 371 Date: Jun. 7, 2012

(30) Foreign Application Priority Data
Nov. 5, 2011 (CN) 201120435654.9

(51) Int. Cl. F26B 25/08

(52) U.S. Cl. 34/202

(57) ABSTRACT

This invention belongs to a technical field of a hand dryer and, more particularly, relates to an air inlet and outlet device of a hand dryer. The air inlet and outlet device including a base, a fan fixedly connected with the base, an electric heater connected with the fan, an air inlet, and an air outlet. The top of the air outlet is in a parabolic shape to improve the efficiency of flowing out of air. A baffle is disposed inside the air inlet to divide the air inlet into two chambers, and one or more baffles are disposed at the air outlet to prevent the leakage of motor sound from the air inlet and the air outlet. The invention has a compact structure, a low noise, and a high efficiency of flowing out of the air and is applicable to different hand dryers.

### BACKGROUND OF THE INVENTION

1. Field of the Invention

This invention belongs to a technical field of a hand dryer and, more particularly, relates to an air inlet and outlet device of a hand dryer.

2. Description of the Related Art

Although the present hand dryer has a variety of types, however, most hand dryers implement the heating function through electric heating. Air blown out from a fan becomes hot air after being heated by a heating element and thus dries the water on an individual's hands. If the drying speed is to be improved, the temperature of the heating element needs to be increased. In order to avoid hurting the individual's hands in high temperature, air volume needs to be increased, and the power of the fan needs to be increased too, which makes a loud noise. In addition, since the hand dryer inevitably sucks in surrounding foreign matters, the efficiency of flowing in and out of the air is impacted. Therefore, the hand dryer needs to be further improved.

### BRIEF SUMMARY OF THE INVENTION

This invention is to provide an air inlet and outlet device of a hand dryer, with a compact structure, a low noise, and a high efficiency of flowing out of air.

The invention is realized by the following.

An air inlet and outlet device of a hand dryer includes a base, a fan fixedly connected with the base, an electric heater connected with the fan, an air inlet, and an air outlet. A baffle is disposed inside the air inlet to divide the air inlet into two chambers, one or more baffles are disposed inside the air outlet, and the top of the air outlet is in a parabolic shape.

A small baffle is disposed at two sides below the baffle inside the air inlet, respectively.

The baffle and the small baffle inside the air inlet are integrated with the base and are fixedly connected with an air inlet cover plate to form the air inlet.

The baffle disposed inside the air outlet is fixedly connected with an air drum via a compression plate connected with the baffle.

The air outlet is of a detachable connection structure, and the section of an air outlet passage of the air outlet is rectangular, circular, elliptic, or ring fan-shaped.

Compared with the prior art, the invention has outstanding advantages as follows.

1. The baffle disposed inside the air inlet and outlet of the invention can prevent the leakage of motor sound, reduce noise, prevent the entry of foreign matters and improve the efficiency of flowing in and out of the air.

2. The invention is provided with a baffle dividing the air inlet into two chambers, and a small baffle is disposed on two sides below the baffle, respectively. Thus, the inlet air is enabled to enter in the form of two air flows spirally. The top of the air outlet is in a parabolic shape, and thus the efficiency of flowing out of the air is improved.

3. The air outlet of the invention is of a detachable connection structure, and the section of an air outlet passage of the air outlet is rectangular, circular, elliptic, ring fan-shaped, or in other shapes. Thus different types of hand dryers can be formed by replacing the air outlet.

4. The invention has a compact structure and is applicable to various hand dryers.

### BRIEF DESCRIPTION OF THE DRAWINGS

FIG. 1 is a stereo schematic diagram of this invention;

FIG. 2 is a side section diagram of the invention;

FIG. 3 is an enlarged schematic diagram showing the top of an air outlet of the invention;

FIG. 4 is a stereo schematic diagram showing a base of the invention; and

FIG. 5 is a connection schematic diagram showing an air outlet baffle and a compression plate of the invention.

### DETAILED DESCRIPTION OF THE INVENTION

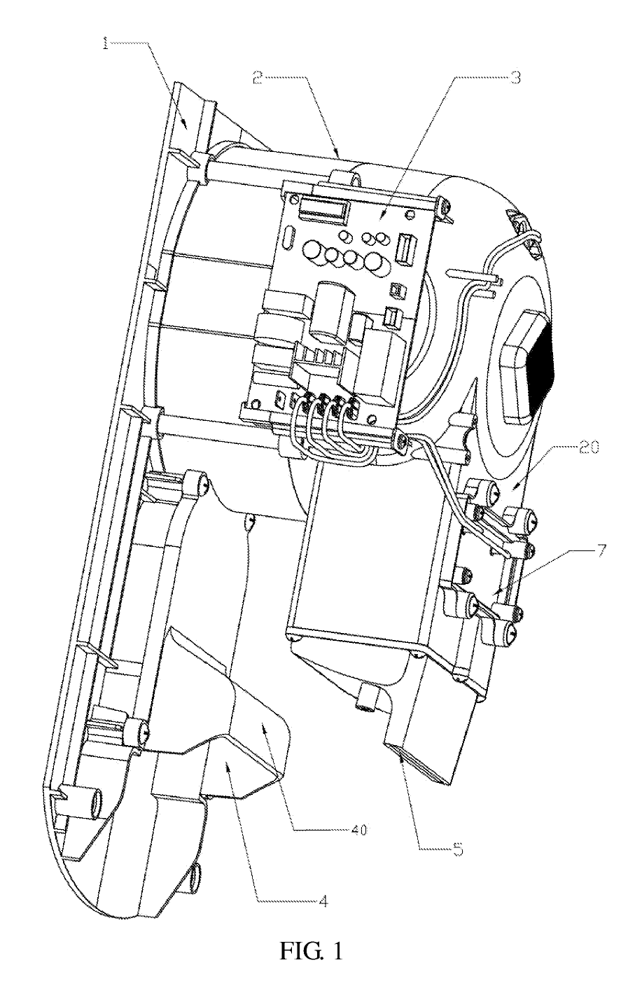

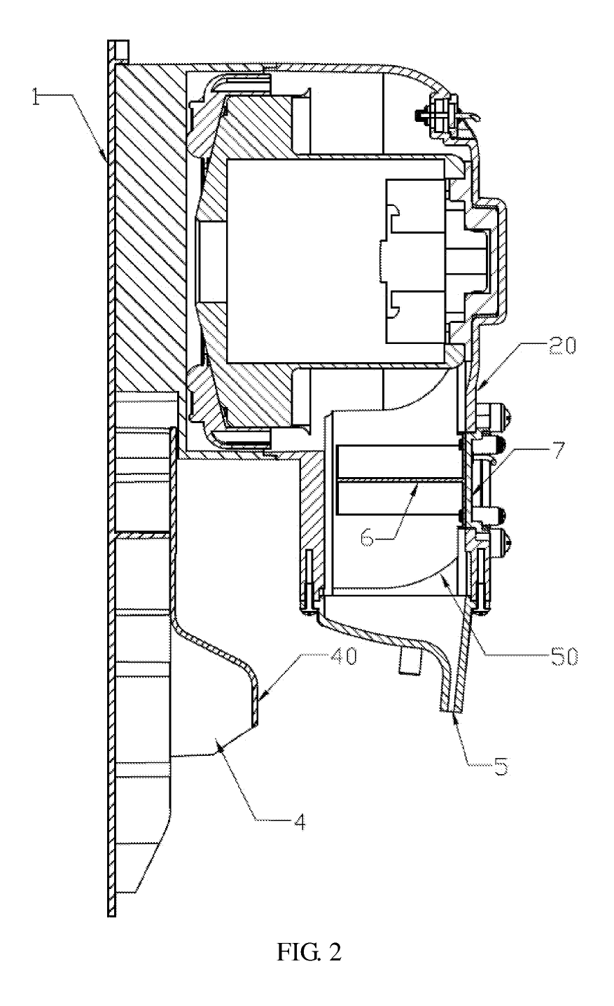

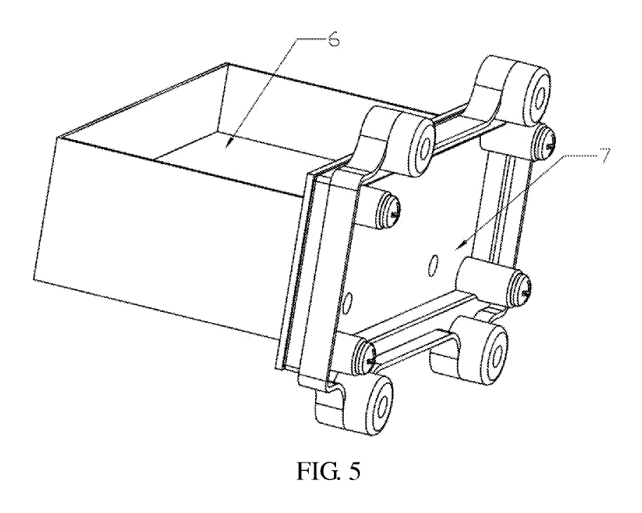

This invention is further described below by a specific embodiment, with reference to FIG. 1 to FIG. 5.

An air inlet and outlet device of a hand dryer includes a base 1, a fan 2 fixedly connected with the base, an electric heater 3 connected with the fan, an air inlet 4, and an air outlet 5. A baffle 10 is disposed inside the air inlet 4 to divide the air inlet into two chambers to prevent the entry of foreign matters and the leakage of motor sound. One or more baffles 6 are disposed inside the air outlet 5 to prevent the entry of the foreign matters and the leakage of the motor sound.

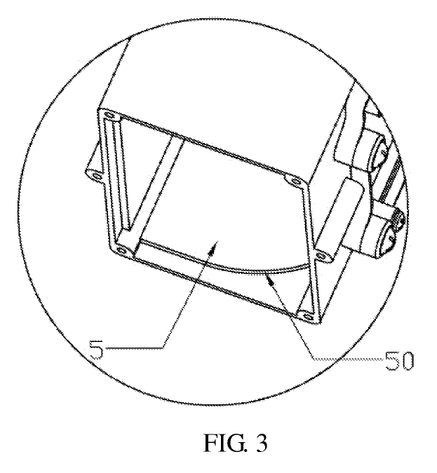

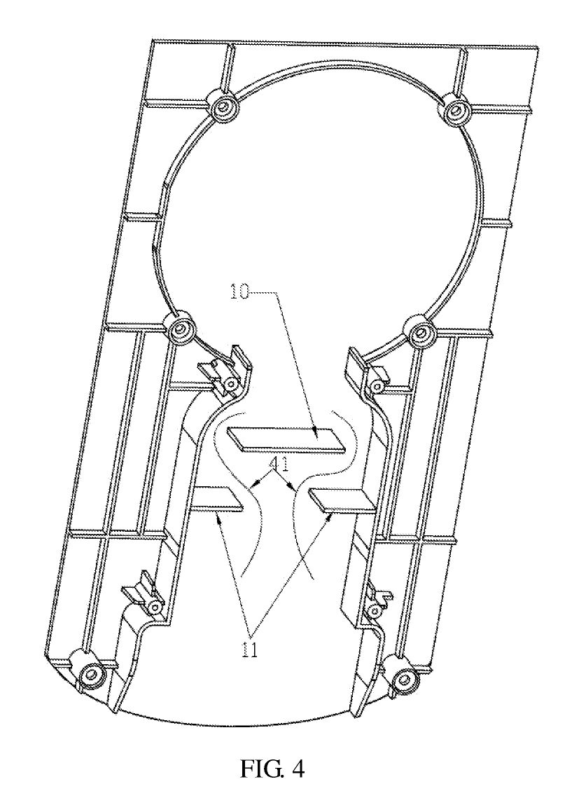

A small baffle 11 is disposed at two sides below the baffle inside the air inlet 4, respectively, enabling the inlet air to enter the fan in the form of two air flows 41 spirally (for example, 41 shown in FIG. 4). The top 50 of the air outlet is in a parabolic shape (as shown in FIG. 3) to improve the efficiency of flowing out of the air.

The baffle 10 and the small baffle 11 inside the air inlet 4 are integrated with the base 1 and are fixedly connected with an air inlet cover plate 40 to form the air inlet.

The one or more baffles 6 disposed inside the air outlet 5 are fixedly connected with an air drum 20 via a compression plate 7 (as shown in FIG. 4) connected with the baffle 6. The air outlet is of a detachable connection structure, and the section of an air outlet passage of the air outlet is rectangular, circular, elliptic, ring fan-shaped, or in other shapes. Thus, different types of hand dryers can be formed by replacing the air outlet, with high flexibility.

The above embodiment is only a preferred embodiment of the invention and is not intended to limit the implementation scope of the invention. Therefore, any equivalent changes made according to the shape, structure and principle of the invention are deemed to be included within the protection scope of the invention.

1. An air inlet and outlet device of a hand dryer, comprising: a base, a fan fixedly connected with the base, an electric heater connected with the fan, an air inlet, and an air outlet, wherein a baffle is disposed inside the air inlet to divide the air inlet into two chambers, one or more baffles are disposed inside the air outlet, and the top of the air outlet is in a parabolic shape.

2. The air inlet and outlet device of the hand dryer according to claim 1, wherein a small baffle is disposed at two sides below the baffle inside the air inlet, respectively.

3. The air inlet and outlet device of the hand dryer according to claim 2, wherein the baffle and the small baffle inside the air inlet are integrated with the base and are fixedly connected with an air inlet cover plate to form the air inlet.

4. The air inlet and outlet device of the hand dryer according to claim 1, wherein the baffle disposed inside the air outlet is fixedly connected with an air drum via a compression plate connected with the baffle.

5. The air inlet and outlet device of the hand dryer according to claim 1, wherein the air outlet is of a detachable connection structure, and the section of an air outlet passage of the air outlet is rectangular, circular, elliptic, or ring fan-shaped.

6. The air inlet and outlet device of the hand dryer according to claim 2, wherein the air outlet is of a detachable connection structure, and the section of an air outlet passage of the air outlet is rectangular, circular, elliptic, or ring fan-shaped.

7. The air inlet and outlet device of the hand dryer according to claim 3, wherein the air outlet is of a detachable connection structure, and the section of an air outlet passage of the air outlet is rectangular, circular, elliptic, or ring fan-shaped.

8. The air inlet and outlet device of the hand dryer according to claim 4, wherein the air outlet is of a detachable connection structure, and the section of an air outlet passage of the air outlet is rectangular, circular, elliptic, or ring fan-shaped.
